(19) United States
(12) Patent Application Publication
(10) Pub. No.: US 2025/0201461 A1
(43) Pub. Date: Jun. 19, 2025

(54) Coil Component

(71) Applicant: SUMIDA CORPORATION, Tokyo (JP)

(72) Inventor: Mitsugu KAWARAI, Natori City (JP)

(21) Appl. No.: 19/066,385

(22) Filed: Feb. 28, 2025

Related U.S. Application Data
(63) Continuation of application No. PCT/JP2022/036702, filed on Sep. 30, 2022.

(51) Int. Cl. H01F 17/04; H01F 27/00; H01F 27/02

(52) U.S. Cl. CPC H01F 17/041; H01F 27/006; H01F 27/022

(57) ABSTRACT

A coil component includes a coil, a magnetic core which is housed inside the coil, and a fixing unit which fixes the magnetic core to the coil such that the magnetic core is located within the coil in an axial direction. The coil is configured to include a winding wire which extends helically. The magnetic core has a high magnetic permeability and is housed in a central core portion which is inside the coil.

### CROSS REFERENCE TO RELATED APPLICATIONS

This application is a Continuation of International Patent Application No. PCT/JP2022/036702, filed on Sep. 30, 2022, which is expressly incorporated herein by reference in its entirety.

### BACKGROUND

### Technical Field

The present invention relates to a coil component including a magnetic core and a coil.

### Related Art

For coil components used in large-current circuits, it is necessary to improve superimposition characteristics and reduce a DC resistance. This arouses the need to increase the sizes of coil components. In particular, a magnetic material used in a large-sized coil component is required to have a high magnetic permeability.

For example, some coil components are produced by mixing metal powder with resin and putting the mixture in a mold together with a coil and a magnetic core and performing compression molding (a metal composite).

Along with an increase in size of a large-sized coil component, a molding machine for molding such a coil component also increases in size because of the need for increasing a molding pressure, which leads to a significant increase in cost.

To cope with the problem with the increase in molding pressure, there is a need for a molding material moldable at a low molding pressure and a molding method capable of molding at a low molding pressure. A magnetic material moldable at low pressure can be achieved by using relatively spherical metal magnetic powder, compounding a relatively large amount of thermoset resin which melts at about 100° C. or more, and molding the compound at a temperature equal to or more than a melt temperature of the resin.

Such a material thermoformable at low pressure is disadvantageous in that a high magnetic permeability cannot be achieved because the metal powder is spherical, and a large amount of non-magnetic resin ingredient is compounded.

Since a magnetic material thermoformable at low pressure is unable to achieve a high magnetic permeability, the magnetic material cannot have characteristics required of a large-sized coil component.

As measures to remedy the problem, there is available a method which includes arranging, at a part of a magnetic circuit of a coil component, a high-permeability magnetic core molded and fired in advance and integrally molding the coil component using the magnetic material thermoformable at low pressure such that the magnetic core and a coil are buried. As for the method, it is best in terms of stability of characteristics to arrange a high-permeability magnetic core at a center of a central core portion of a coil.

Coil positioning in a mold can be performed by holding a flat wire end of a coil using a flat wire with the mold.

A high-permeability magnetic core needs to be held inside by a material thermoformable at low pressure without being exposed on a product surface in order to prevent rust formation and moisture absorption. For this reason, the high-permeability magnetic core cannot be positioned in contact with a mold inner surface. This results in the difficulty of positioning the high-permeability magnetic core to be arranged at a coil central core portion.

For example, in the coil component described in Japanese Patent Laid-Open No. 2020-167304 (Patent Document 1), a high-permeability magnetic molded body as a magnetic core has a flange portion, and a coil is mounted on an upper surface of the flange portion, thereby positioning the magnetic core and the coil.

However, since the flange portion of the magnetic core is formed larger than a central core portion of the coil in the coil component of Patent Document 1, the high-permeability magnetic core including the flange portion cannot be held inside by the coil. For this reason, a dimension error for each manufacturing cycle may cause a change in a magnetic flux flow to destabilize inductance.

To cause a coil to hold a magnetic core inside, the method described in Patent Document 1 cannot be used, and positioning between the magnetic core and the coil cannot be performed. For this reason, the magnetic core may transit from a state of being fit in the coil to a state of being out of the coil. In this case, a magnetic flux flow changes to destabilize inductance.

The present invention has been made in view of the above-described problem, and has as its object to provide a coil component which allows positioning between a magnetic core and a coil.

### SUMMARY

A coil component according to the present invention includes a coil, a magnetic core which is housed inside the coil, and a fixing unit which fixes the magnetic core to the coil such that the magnetic core is located within the coil in an axial direction.

### Effect of the Invention

According to the present invention, it is possible to fix the magnetic core within the coil and stabilize inductance without changing a magnetic flux flow.

### BRIEF DESCRIPTION OF THE DRAWINGS

FIG. 1 is a plan view of a coil component.

FIG. 2 is a cross-sectional view of the coil component and is a view showing a cross-section along A-A in FIG. 1.

FIG. 3 is a plan view showing a coil.

FIG. 4 is a plan view showing a state where a magnetic core is inserted in a central core portion of the coil.

FIG. 5 is a plan view showing a state after winding end portions of the coil are bending-deformed.

FIG. 6 is a cross-sectional view of a coil component according to a first modification and is a view showing a cross-section corresponding to the cross-section along A-A in FIG. 1.

FIG. 7 is a cross-sectional view of a coil component according to a second modification and is a view showing a cross-section corresponding to the cross-section along A-A in FIG. 1.

### DETAILED DESCRIPTION

An embodiment of the present invention will be described below with reference to the drawings.

Note that the embodiment to be described below is merely an example for facilitating understanding of the present invention and does not limit the present invention. That is, the shapes, dimensions, arrangements, and the like of members to be described below can be modified and improved without departing from the gist of the present invention, and the present invention, of course, includes equivalents thereof.

Various types of constituent elements of the present invention need not exist separately and independently, and a plurality of constituent elements may be formed as a single constituent element, one constituent element may be formed as a plurality of divided constituent elements, a certain constituent element may be formed as a part of another constituent element, or a part of a certain constituent element and a part of another constituent element may overlap with each other.

In all the drawings, same constituent elements are denoted by same reference numerals, and a redundant description will not be repeated. Although an explanation may be given with defined upward and downward directions in this specification, the upward and downward directions are set for the sake of convenience in explaining the relative relationships of constituent elements, and the explanation does not limit a direction when a product according to the present invention is manufactured or used.

### <Outline of Coil Component>

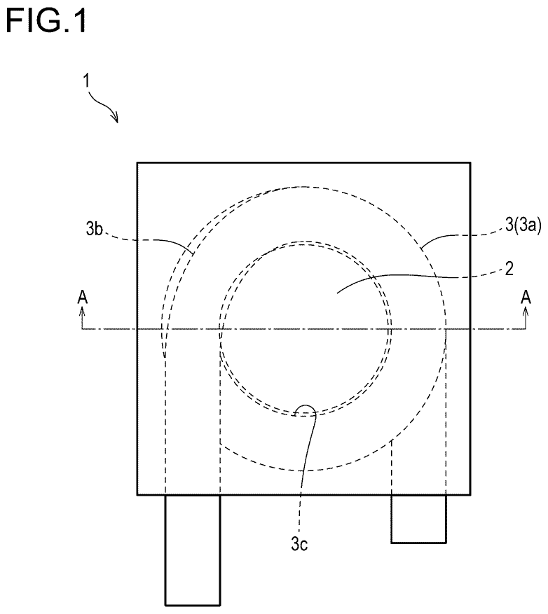

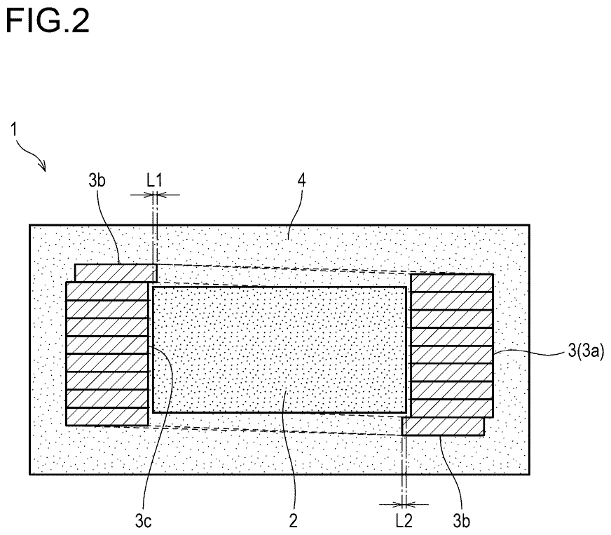

First, an outline of a coil component 1 will be described mainly with reference to FIGS. 1 and 2.

FIG. 1 is a plan view of the coil component 1, and FIG. 2 is a cross-sectional view of the coil component 1 and is a view showing a cross-section along A-A in FIG. 1.

The coil component 1 includes a coil 3, a magnetic core 2 which is housed inside the coil 3, and a fixing unit (winding end portions 3b) which fixes the magnetic core 2 to the coil 3 such that the magnetic core 2 is located within the coil 3 in an axial direction.

The fixing unit in the present embodiment constitutes the winding end portion 3b of a winding wire 3a constituting the coil 3 that each intersect at least a part of the coil 3 in the axial direction. In other words, the winding end portion 3b overlaps at least part of the coil 3 in the axial direction. Here, it is sufficient if at least one of the winding end portions 3b is used as a fixing unit to fix the magnetic core 2 to the coil 3. As described later, each of the winding end portions 3b at the two end portions may be used as a fixing means to fix the magnetic core 2 to the coil 3.

The above-described fixing unit, however, is not limited to this configuration and may be an adhesive or the like (not shown in the drawings). That is, the magnetic core 2 may be fixed to the coil 3 by an adhesive force of the adhesive.

According to the above-described configuration, the fixing unit (winding end portion 3b) can fix the magnetic core 2 within the coil 3, and the magnetic core 2 does not transition from a state of being fit in the coil 3 to a state of being out of the coil 3. This does not change a magnetic flux flow and allows stabilization of inductance. For this reason, the large-sized coil component 1 that is excellent in inductance characteristics and is easily moldable can be obtained.

Specifically, at least one of the winding end portions 3b is positioned outside the entire magnetic core 2 in the axial direction. In other words, the entire magnetic core 2 is located on the side of at least one of the two winding end portions 3b as compared to the other of winding end portions 3b in the axial direction. In other words, the end surface (the upper surface or the lower surface) that is located furthest out in the axial direction of the magnetic core 2 is located on the side of at least one of the two winding end portions 3b as compared to the other of winding end portions 3b in the axial direction. This prevents the magnetic core 2 from moving in the axial direction relative to the coil 3.

In this embodiment, as described later, the two winding end portions 3b are the fixing unit. In this case, the two winding end portions 3b are located outside the axial direction of the magnetic core 2, and the magnetic core 2 is contained within the coil 3. In other words, the entire magnetic core 2 is located between the two winding end portions 3b in the axial direction. In other words, the both end surfaces that are located furthest out on opposite axial sides of the magnetic core 2 are located between the two winding end portions 3b in the axial direction. This prevents the magnetic core 2 from moving due to the two winding end portions 3b.

### <Configuration of Coil Component>

Configurations of portions of the coil component 1 will be described.

The magnetic core 2 has a high magnetic permeability, a magnetic permeability u equal to or more than 30 H/m and equal to or less than 100 H/m, and is formed by molding or firing.

The magnetic core 2 according to the present embodiment is molded or fired using an Fe—Si—Cr alloy (with a magnetic permeability μ of 60 H/m), and has an outer diameter of 15.6 mm and a height of 7.5 mm.

The coil 3 is configured to include the winding wire 3a that is wound around the magnetic core 2. A dimension in the axial direction of the coil 3 is larger than a dimension in a winding axis direction of the magnetic core 2.

The coil 3 according to the present embodiment is, for example, an edgewise coil which is formed from an insulation-coated flat wire having a width of 5.0 mm and a thickness of 1.0 mm. An inner diameter of the coil 3 is 16.0 mm, and the number of turns is 8.5.

As shown in FIG. 2, two end portions (the winding end portions 3b) in the axial direction in the coil 3 according to the present embodiment are located outside the magnetic core 2 in the axial direction. The fixing unit constitutes the winding end portions 3b that are wirings of the coil 3 at the two end portions, and a winding inner diameter of the coil 3 at (at least a part of) each winding end portion 3b is smaller than outer diameters of an upper surface and a lower surface facing the winding end portions 3b in the magnetic core 2. Thus, the winding end portion fixes the magnetic core to the coil such that the magnetic core is located within the coil in an axial direction as the fixing unit.

“The winding wire 3a” is a site extending helically, and “the winding inner diameter” is assumed to be a length twice a curvature radius of the winding wire 3a. Since a winding inner diameter of at least a part of each winding end portion 3b is smaller than the outer diameters of the upper surface and the lower surface of the magnetic core 2, the winding end portion 3b is located to lie on an extension in the axial direction of the magnetic core 2. The height of the high-permeability magnetic core 2 that is disposed in a central core portion 3c is smaller than a distance between the two winding end portions 3b.

Since the winding inner diameter of at least a part of each of the winding end portions 3b at the two end portions of the coil 3 is smaller than the outer diameters of the upper and lower surfaces of the magnetic core 2, the two winding end portions 3b are located to lie on the extensions in the axial direction of the magnetic core 2.

The sum of widths of overlap between the upper and lower winding end portions 3b and the magnetic core 2 (the total of the widths of overlap L1 and widths of overlap L2 in FIG. 2) is smaller than a line width of the coil 3. A turn vertically adjacent to each winding end portion 3b in the winding wire 3a and the winding end portion 3b are formed to overlap. Since the coil 3 is configured in this manner, magnetic powder 4 can be inhibited from entering into the winding wire 3a.

Here, the width of overlap L1 or L2 is the dimensions of the area where the winding end portion 3b and the magnetic core 2 overlap each other in the axial direction, and is the maximum dimension of this area in the radial direction of coil 3.

According to the above-described configuration, the winding inner diameter of (at least a part of) each of the winding end portions 3b at the two end portions of the coil 3 is smaller than the outer diameters of the upper and lower surfaces of the magnetic core 2, and movement of the magnetic core 2 can be restricted from two sides in the axial direction. In particular, the magnetic core 2 can be positioned not by an adhesive but by the winding end portions 3b. Unlike a case where an adhesive different in coefficient of thermal expansion from a different member intervenes, a crack due to, for example, application of heat does not appear.

The two end portions (the winding end portions 3b) of the coil 3 may be in surface contact with the upper and lower surfaces of the magnetic core 2 and press the upper and lower surfaces of the magnetic core 2 from the two sides in the axial direction.

That is, a length in the axial direction of the magnetic core 2 is larger than lengths in the axial direction between the winding end portions 3b on the two sides in the natural state, and an elastic restoring force toward an inner side in the axial direction may be applied from the coil 3 to the magnetic core 2. The natural state here is the state before magnetic core 2 and coil 3 are assembled. In other words, in the natural state, coil 3 is not stretched by magnetic core 2 in the axial direction.

According to the configuration, the magnetic core 2 and the coil 3 can be brought into close contact, and relative movement (play) of the magnetic core 2 relative to the coil 3 can be inhibited.

However, the present invention is not limited to this configuration. Since the inductance can be sufficiently stabilized if the magnetic core 2 can be housed within the central core portion 3c of the coil 3, there may be gaps between the upper and lower winding end portions 3b of the coil 3 and the magnetic core 2.

As an alternative to the present embodiment, the winding end portion 3b may simply be in contact with, rather than pressed against, the upper and lower surfaces of the magnetic core 2. With this configuration, the relative movement of the magnetic core 2 with respect to the coil 3 is sufficiently suppressed, while the magnetic core 2 is prevented from deforming unexpectedly.

Alternatively, the winding end portion 3b may be separated from the magnetic core 2 in the axial direction. In other words, there may be a gap between the winding end portion 3b and the magnetic core 2 in the axial direction.

As shown in FIGS. 1 and 2, the coil component 1 further includes a coating body (the magnetic powder 4) which is lower in magnetic permeability than the magnetic core 2, and the magnetic powder 4 encases the coil 3 and the magnetic core 2.

Specifically, the magnetic powder 4 is a mixture of metal magnetic powder and thermoset resin. More specifically, the magnetic powder 4 contains an alloy having as the main ingredient Fe—Si—Cr and having an average grain diameter of about 10 μm and a thermoset epoxy resin, and the percentage by which the resin is compounded is 3%.

The expression “the magnetic powder 4 encases the coil 3 and the magnetic core 2” specifically means that the magnetic powder 4 holds, inside, the coil 3 and the magnetic core 2 except coil end portions of the coil 3 without exposing the coil 3 and the magnetic core 2 at a surface of the magnetic powder 4.

According to the above-described configuration, even the coil component 1 including the coating body can enjoy the above-described effect. To put it the other way around, the coil component 1 does not necessarily need to include the magnetic powder 4.

A high-permeability core was not inserted as a central core, and processes other than the insertion were performed in the same manner as a manufacturing method for the coil component 1, thereby fabricating a coreless coil component (not shown in the drawings) with equal inductance. A DC resistance of the coreless coil component was compared with that of the coil component 1. Specifically, the coil component 1 and the coreless coil component were each set to have equal product outside dimensions, 30 mm long, 30 mm wide, and 15 mm high, and have an equal inductance of 15.0 μH.

To equalize the product outside dimensions of the coreless coil component and the coil component 1, the coreless coil component and the coil component 1 were made different in configuration.

Specifically, the coreless coil component included an edgewise coil composed of an insulation-coated flat wire which was 5.0 mm wide and 0.7 mm thick (thinner than the coil component 1). A coil inner diameter of the component was 16.0 mm, and the number of turns was set to 11.5 (larger than that of the coil component 1). Forming was performed such that two end portions serving as leaders of the coil extended in parallel.

The DC resistance of the coreless coil component was 4.2 mΩ. As compared with this, the DC resistance was 2.3 mΩ in the coil component 1 according to the present embodiment, and good DC superimposition characteristics were obtained.

### <Manufacturing Procedure for Coil Component>

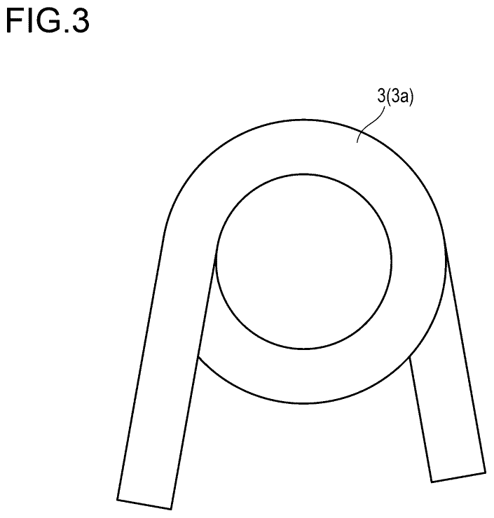

A manufacturing procedure for the coil component 1 will be described mainly with reference to FIGS. 3 to 5.

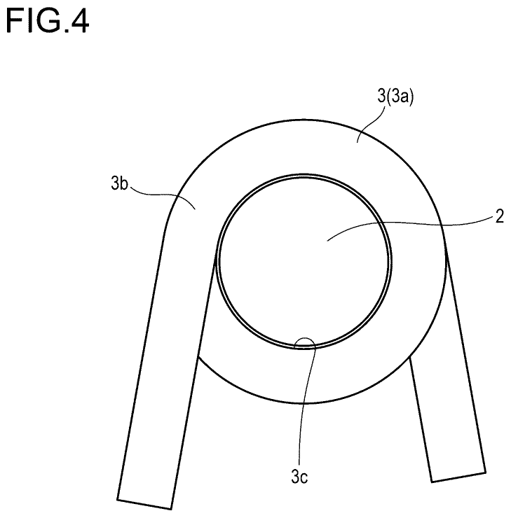

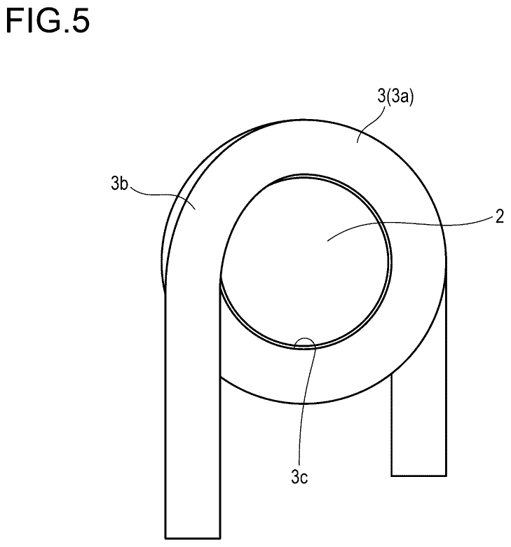

FIG. 3 is a plan view showing the coil 3, FIG. 4 is a plan view showing a state where the magnetic core 2 is inserted in the central core portion 3c of the coil 3, and FIG. 5 is a plan view showing a state after the winding end portions 3b of the coil 3 are bending-deformed.

First, a flat wire is wound around a central core (not shown in the drawings) which is a winding jig to form the winding wire 3a of the coil 3 shown in FIG. 3. At this time, turns of the winding wire 3a are formed vertically in close contact with each other in order to inhibit the magnetic powder 4 from coming between the turns to degrade the inductance characteristics.

As shown in FIG. 3, before the magnetic core 2 is housed in the central core portion 3c of the coil 3, the end portions of the coil 3 to be led out from the magnetic powder 4 are formed to be opened by an angle of generally 10° toward the outside (in directions away from each other).

In the present embodiment, the winding jig is removed, and the high-permeability magnetic core 2 is inserted into the central core portion 3c of the coil 3, as shown in FIG. 4. After that, the two winding end portions 3b at the two end portions of the coil 3 are tightened to come to inside the coil inner diameter (outer peripheries of the central core portion 3c and the magnetic core 2), as shown in FIG. 5.

Specifically, in a state where the magnetic core 2 is temporarily fixed with a fixing jig (not shown in the drawings), the winding end portions 3b at the two end portions are subjected to press bending to be bent toward an inner side (an axial center side) such that the winding end portions 3b extend in parallel with each other, as shown in FIG. 5. More specifically, at the time of press bending the winding end portions 3b at the two end portions, the winding end portions 3b at the two end portions are deformed to be close to each other such that the winding end portions 3b at the two end portions are located to extend in parallel due to elastic restoration of the winding end portions 3b at the two end portions.

As shown in FIGS. 2 and 5, the winding end portions 3b at the upper and lower end portions of the coil 3 are located closer to a center side than a peripheral surface of the inserted high-permeability magnetic core 2. With this configuration, the magnetic core 2 is fixed by the winding end portions 3b and is positioned.

Note that the present invention is not limited to the above-described method that simultaneously press bends the winding end portions 3b at the two end portions of the coil 3. After one of the winding end portions 3b is subjected to press bending, the magnetic core 2 may be inserted into the central core portion 3c such that the magnetic core 2 is located on the winding end portion 3b, and the other winding end portion 3b may be subjected to press bending.

Additionally, as in a first modification (to be described later), only one side (a lower side) of the winding wire 3a may be subjected to press bending so as to form the winding end portion 3b that is located closer to the center side than the peripheral surface of the magnetic core 2.

The coil 3, in which the fabricated magnetic core 2 is inserted, is set in a mold (not shown in the drawings). Inside dimensions of the mold are 30 mm long and 30 mm wide. Granulated powder (the magnetic powder 4) in which metal magnetic powder and resin are mixed is further charged into the mold.

A load is applied to the magnetic powder 4 within the mold (not shown in the drawings) to perform compression molding. A molded body (not shown in the drawings) is taken out of the mold, and hardening heat treatment is performed in a constant-temperature bath at 150° C. for two hours. After that, end portions of the coil 3 protruding from the molded body are subjected to coating removal and bending forming to form an external electrode.

With the above-described processes, the coil component 1 shown in FIGS. 1 and 2, which holds the high-permeability magnetic core 2 in the central core portion 3c and whose outside dimensions are 30 mm long and wide and 15 mm high, can be fabricated.

### First Modification

In the above-described embodiment, both of the winding end portions 3b at the upper and lower end portions of the coil 3 have been described as being subjected to press bending so as to be located closer to the center side than the peripheral surface of the magnetic core 2. The present invention, however, is not limited to this configuration.

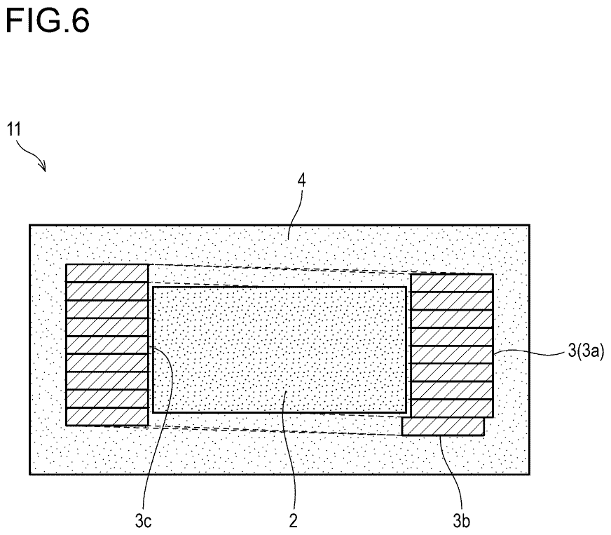

A coil component 11 according to a first modification will be described mainly with reference to FIG. 6. FIG. 6 is a cross-sectional view of the coil component 11 according to the first modification and a view showing a cross-section corresponding to the cross-section along A-A in FIG. 1.

In the coil component 11 according to the present modification, an end portion (the winding end portion 3b) on at least one side (a lower side in the present modification) in an axial direction in the coil 3 lies outside the magnetic core 2 in the axial direction.

A fixing unit which fixes the coil 3 constitutes the winding end portion 3b that is the winding wire 3a of the coil 3 at the end portion on at least the one side (the lower side in the present modification). A winding inner diameter of the coil 3 at (at least a part of) the winding end portion 3b is smaller than an outer diameter of an upper surface or a lower surface (the lower surface in the present modification) facing the winding end portion 3b in the magnetic core 2. Thus, each of the winding end portions of two end portions fixes the magnetic core to the coil such that the magnetic core is located within the coil in an axial direction as the fixing unit.

In this embodiment, one of the two winding end portions 3b (the lower side in the present modification) overlaps with the magnetic core 2 in the axial direction. The other of the two winding end portions 3b (the upper side in the present modification) does not overlap with the magnetic core 2 in the axial direction. In other words, the entire top surface of the magnetic core 2 is exposed from the upper winding end portion 3b.

A width of overlap between the winding end portion 3b and the magnetic core 2 is smaller than one-half of a line width of the coil 3. Since the coil 3 is configured in this manner, the magnetic powder 4 can be inhibited from entering into the winding wire 3a.

According to the above-described configuration, relative positioning between the magnetic core 2 and the coil 3 can be performed by arranging the winding end portion 3b on the one side with a smaller winding diameter in the coil 3 outside the magnetic core 2 in the axial direction and inserting the magnetic core 2 into the coil 3.

Note that, as for “the upper surface or the lower surface facing the winding end portion 3b in the magnetic core 2”, the winding end portion 3b with a smaller winding inner diameter may be arranged on the lower side corresponding to the lower surface in particular in the magnetic core 2. With this configuration, the magnetic core 2 and the winding end portion 3b come into contact due to the weight of the magnetic core 2. At the time of molding a coating body (the magnetic powder 4), relative positioning between the coil 3 and the magnetic core 2 can be easily performed.

### Second Modification

Although the coil 3 according to the above-described embodiment has been described as a solenoidal one (with a single-layer configuration) which is formed from a flat wire, the present invention is not limited to this configuration. A round wire may be adopted or a multilayer configuration may be adopted instead of the single-layer configuration.

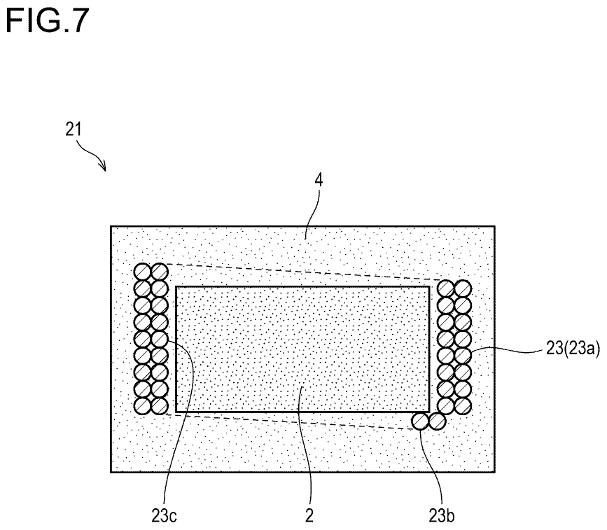

A coil component 21 according to a second modification will be described mainly with reference to FIG. 7. FIG. 7 is a cross-sectional view of the coil component 21 according to the second modification and is a view showing a cross-section corresponding to the cross-section along A-A in FIG. 1.

The coil component 21 includes a coil 23 with a two-layer configuration which has a winding wire 23a as a round wire.

In the coil component 21 according to the present modification, an end portion (a winding end portion 23b) on at least one side (a lower side in the present modification) in an axial direction in the coil 23 lies outside the magnetic core 2 that is housed in a central core portion 23c of the coil 23 in the axial direction.

A fixing unit which fixes the coil 23 constitutes the winding end portion 23b that is the end portion on at least the one side (the lower side in the present modification) and is provided at an inner layer of the winding wire 23a of the coil 23. A winding inner diameter of the coil 23 at (at least a part of) the winding end portion 23b is smaller than an outer diameter of an upper surface or a lower surface (the lower surface in the present modification) facing the winding end portion 23b in the magnetic core 2.

A combination of the winding end portion 23b and a turn covering an outer periphery thereof which are provided on the one side (the lower side in the present modification) in the axial direction of the coil 23 is formed so as to overlap with a combination of a turn upwardly adjacent to the winding end portion 23b and a turn covering an outer periphery thereof in the winding wire 23a.

Specifically, the turn covering the outer periphery of the winding end portion 23b is formed so as to overlap with the turn upwardly adjacent to the winding end portion 23b in the winding wire 23a.

Since the coil 23 is configured in this manner, the magnetic powder 4 can be inhibited from entering into the winding wire 23a.

If the winding end portion 23b is formed only at an end portion at which winding of the coil 23 starts like the present modification, the coil 23 may have any number of layers (a configuration in which an arbitrary number of layers are laid on top of one another in a direction perpendicular to the axial direction).

Additionally, even in a coil with a multilayer configuration (a configuration with layers laid on top of one another in a direction perpendicular to an axial direction), winding end portions may be provided at upper and lower (winding start and winding termination) end portions (at which winding starts and stops). For example, such a configuration can be implemented if even a coil with a multilayer configuration is a coil which terminates winding at an innermost layer (a coil in which a last turn of a winding wire is at the innermost layer).

The above-described embodiment and modifications include the following technical ideas.

(1)

A coil component comprising
a coil,
a magnetic core which is housed inside the coil, and
a fixing unit which fixes the magnetic core to the coil such that the magnetic core is located within the coil in an axial direction.
   (2)

The coil component according to (1), wherein
an end portion on at least one side in the axial direction in the coil is outside the magnetic core in the axial direction, and
the fixing unit comprises a winding end portion which is a winding of the coil at the end portion on the at least one side, and a winding inner diameter of the coil at the winding end portion is smaller than an outer diameter of an upper surface or a lower surface facing the winding end portion in the magnetic core.
   (3)

The coil component according to (2), wherein
two end portions in the axial direction in the coil are outside the magnetic core in the axial direction, and
the fixing unit comprises winding end portions which are windings of the coil at the two end portions, and winding inner diameters of the coil at the winding end portions are smaller than the respective outer diameters of the upper surface and the lower surface facing the winding end portions in the magnetic core.
   (4)

The coil component according to (3), wherein the two end portions of the coil are in surface contact with the upper surface and the lower surface, respectively, of the magnetic core and press the upper surface and the lower surface of the magnetic core from two sides in the axial direction.

(5)

The coil component according to any one of (1) to (4), further comprising
a coating body which is lower in magnetic permeability than the magnetic core, wherein
the coating body encases the coil and the magnetic core.
   (6)

A coil component comprising:
a coil; and
a magnetic core which is housed inside the coil, wherein
an end portion on at least one side in the axial direction in the coil is outside the magnetic core in the axial direction,
the end portion on the at least one side in the axial direction in the coil comprises a winding end portion which is a winding of the coil, a winding inner diameter of the coil at the winding end portion is smaller than an outer diameter of an upper surface or a lower surface facing the winding end portion in the magnetic core, and
the winding end portion fixes the magnetic core to the coil such that the magnetic core is located within the coil in an axial direction.
   (7)

A coil component comprising:
a coil; and
a magnetic core which is housed inside the coil, wherein
two end portions in the axial direction in the coil are outside the magnetic core in the axial direction,
the two end portions comprise, respectively, winding end portion which are windings of the coil, and winding inner diameters of the coil at the winding end portions are smaller than the respective outer diameters of the upper surface and the lower surface facing the winding end portions in the magnetic core, and
each of the winding end portions of two end portion fixes the magnetic core to the coil such that the magnetic core is located within the coil in an axial direction.

1. A coil component comprising:
a coil;
a magnetic core which is housed inside the coil; and
a fixing unit which fixes the magnetic core to the coil such that the magnetic core is located within the coil in an axial direction.

2. The coil component according to claim 1, wherein
an end portion on at least one side in the axial direction in the coil is outside the magnetic core in the axial direction, and
the fixing unit comprises a winding end portion which is a winding of the coil at the end portion on the at least one side, and a winding inner diameter of the coil at the winding end portion is smaller than an outer diameter of an upper surface or a lower surface facing the winding end portion in the magnetic core.

3. The coil component according to claim 2, wherein
two end portions in the axial direction in the coil are outside the magnetic core in the axial direction, and
the fixing unit comprises winding end portions which are windings of the coil at the two end portions, and winding inner diameters of the coil at the winding end portions are smaller than the respective outer diameters of the upper surface and the lower surface facing the winding end portions in the magnetic core.

4. The coil component according to claim 3, wherein the two end portions of the coil are in surface contact with the upper surface and the lower surface, respectively, of the magnetic core and press the upper surface and the lower surface of the magnetic core from two sides in the axial direction.

5. The coil component according to claim 1, further comprising
a coating body which is lower in magnetic permeability than the magnetic core, wherein
the coating body encases the coil and the magnetic core.
